(19) United States
(12) Patent Application Publication
(10) Pub. No.: US 2005/0027692 A1
(43) Pub. Date: Feb. 3, 2005

(54) Method, system, and program for accessing data in a database table

(75) Inventors: Kalpana Shyam, Los Altos, CA (US); Paramesh S. Desai, San Jose, CA (US); RamanaKumari M. Croisettier, Morgan Hill, CA (US)

Correspondence Address: KONRAD RAYNES VICTOR & MANN LLP;Suite 210, 315 S. Beverly Drive, Beverly Hills, CA, 90212, US

(73) Assignee: International Business Machines Corporation.

(21) Appl. No.: 10/629,939

(22) Filed: Jul. 29, 2003

(51) Int. Cl. G06F 17/30

(52) U.S. Cl. 707/3

(57) ABSTRACT

Provided are a method, system, and program for accessing data in a database table. A fetch request is received to fetch data from a base table that satisfies a query predicate, wherein rows of the base table are stored in table partitions and wherein there is one index partition for each determined table partition, wherein each index partition includes nodes, wherein each node in each index partition includes at least one key column value from a corresponding table row in the table partition associated with the index partition and a location identifier identifying the corresponding table row in the corresponding table partition. A determination is made of a set of nodes, one from each index partition, whose key column value satisfies the query predicate. One node from the set is selected and data is returned from the table row identified by the location identifier in the selected node in response to the fetch request.

### BACKGROUND OF THE INVENTION

1. Field of the Invention

The present invention relates to a method, system, and program for accessing data in a database table.

2. Description of the Related Art

Database programs include a feature referred to as cursors. A cursor is a named control structure used by an application program to point to a row of interest within some set of rows and to retrieve rows from the set, possibly making updates and deletions. A cursor points to rows from a database table that satisfy a structured query language (SQL) query against the table. The rows in the table that satisfy the SQL query comprise a result table of data. The SQL query includes an SQL SELECT statement and a WHERE clause to qualify rows according to a search condition. An application can then access data on a row-by-row basis from the result table.

If the result table is static and not updateable, then the result table may be materialized in a workfile. Alternatively, the cursor may be dynamic and point directly to the rows in the base table. In such case, the result table is not materialized in a workfile and the cursor is updateable when the base table is updated.

After a cursor is opened or initialized, an application program may issue fetch statements to move a cursor positioned on a row one or more rows, forward or backward, from a current cursor position. In current implementations, if a cursor is implemented as sensitive, then changes made to the database after the result table is materialized are visible to the cursor. The cursor has some level of sensitivity to any updates or deletes made to the rows underlying its result table after the table is materialized. The cursor may further be sensitive to positioned updates or deletes using the same cursor. Additionally, the cursor can have sensitivity to committed changes made outside this cursor. A static cursor specifies that the size of the result table and the order of the rows does not change after the cursor is opened. Rows inserted into the underlying table are not added to the result table regardless of how the rows are inserted. Rows in the result table do not move if columns in the ORDER BY clause are updated in rows that have already been materialized. Positioned updates and deletes are allowed if the result table is updateable. The SELECT statement of a cursor that is defined as SENSITIVE STATIC cannot contain an INSERT statement. Further, a static cursor may have visibility to changes made by this cursor using positioned updates or deletes. Committed changes made outside this cursor are visible with the SENSITIVE option of the FETCH statement. A FETCH SENSITIVE can result in a hole in the result table (that is, a difference between the result table and its underlying base table). If an updated row in the base table of a cursor no longer satisfies the predicate of its SELECT statement, an update hole occurs in the result table. If a row of a cursor was deleted in the base table, a delete hole occurs in the result table. When a FETCH SENSITIVE detects an update hole, no data is returned (a warning is issued), and the cursor is left positioned on the update hole. When a FETCH SENSITIVE detects a delete hole, no data is returned (a warning is issued), and the cursor is left positioned on the delete hole.

Open DataBase Connectivity (ODBC) is a standard database access method to allow applications to access data in a database management system (DBMS). An ODBC driver translates the application's queries into statements that the DBMS understands. The ODBC standards describe scrollable, keyset driven, static and dynamic cursors. The ODBC standards mention that cursors may be updateable or nonupdateable. Cursors are defined as updateable if the application is capable of modifying the data in the cursor result table. As discussed, the result table may be implemented in a work file or comprise the rows pointed to by the cursor in the base table. The ODBC also mentions that when positioned on a row in an updateable cursor, the application can perform position updates or delete operations that target the base table rows used to build the current row in the cursor.

The ODBC defines the following types of cursors:
scrollable cursor: allows the application to fetch forward or backward from the current position, i.e., from anywhere, in the result table. With a scrollable cursor, your application can request by position the data presented in the current row. Typical scrolling requests include moving one row forward, one row back, to the beginning, or to the end of the result table. With a scrollable cursor, the application can request that a certain row of data be made the current row more than once.
forward-only cursor: allows the application to fetch forward serially from the start to end of the result table.
keyset cursor: the rows in the result table are identified by the value present in a designated column.
static cursors contain data that was placed in the cursor when it was created. A static cursor may be sensitive, where changes are accessible to the cursor, or static insensitive where no changes are visible.
dynamic cursors: Dynamic cursors reflect all changes made to the rows in their result table when scrolling through the cursor. The data values, order, and membership of the rows in the result table can change on each fetch. All UPDATE, INSERT, and DELETE statements made by all users are visible through the cursor. Updates are visible immediately if they are made through the cursor. Updates made outside the cursor are not visible until they are committed, unless the cursor transaction isolation level is set to read uncommitted. Updates made outside the cursor by the same transaction as that which defines the cursor are immediately visible.

Cursors may be categorized as forward-only or scrollable. If the cursor is scrollable then they can be either static, keyset or dynamic. Further details of scrollable cursors are described in the copending and commonly assigned patent application entitled “Method, System, and Program for Implementing Scrollable Cursors in a Database”, having U.S. application Ser. No. 09/656,558, filed on Sep. 7, 2000, which patent application is incorporated herein by reference in its entirety.

Current database systems provide static scrollable cursors only. However, static scrollable cursors restrict the applications form being able to fetch newly inserted rows. Furthermore, they require extra disk storage to save the temporary result table per transaction. While some applications prefer to work with a fixed set of rows, at the expense of extra disk storage, there is also an extensive requirement in the industry to be able to scroll on the database table there by having immediate access to the most current data via the access path selected by the database optimizer.

### SUMMARY OF THE PREFERRED EMBODIMENTS

Provided are a method, system, and program for accessing data in a database table. A fetch request is received to fetch data from a base table that satisfies a query predicate, wherein rows of the base table are stored in table partitions and wherein there is one index partition for each determined table partition, wherein each index partition includes nodes, wherein each node in each index partition includes at least one key column value from a corresponding table row in the table partition associated with the index partition and a location identifier identifying the corresponding table row in the corresponding table partition. A determination is made of a set of nodes, one from each index partition, whose key column value satisfies the query predicate. One node from the set is selected and data is returned from the table row identified by the location identifier in the selected node in response to the fetch request.

In further implementations, a determination is made as to whether to modify a direction of the fetch request. The direction of the fetch request is modified if the determination is made to modify the fetch request. And a determination is made of the set of nodes based on the direction of the fetch request.

In still further implementations, a subsequent fetch request is received to fetch data from the base table. A previously selected node selected in a previous fetch request in the set is replaced with one node in the index partition including the previously selected node whose key column value satisfies the query predicate to form a modified set. One node is selected from the modified set and the table row identified by the location identifier in the node selected from the modified set is returned.

Still further, the cached keys are discarded if the fetch request is in an opposite direction of a previous fetch request. A determination is made of a new set of nodes from each index partition. The determined new set of nodes is cached when performing the fetch operation.

### BRIEF DESCRIPTION OF THE DRAWINGS

Referring now to the drawings in which like reference numbers represents corresponding parts throughout:

FIGS. 1a and 1b illustrate a computing environment in which aspects of the invention are implemented in accordance with implementations of the invention;

FIG. 2 illustrates operations performed to create an index in accordance with implementations of the invention;

FIG. 3 illustrates operations performed to add a row to a table in accordance with implementations of the invention;

FIGS. 4, 5, and 6 illustrate operations performed to query a table in accordance with implementations of the invention;

FIGS. 7, 8, 9, and 10 illustrate data structures used to implement a scrollable cursor in a database;

FIG. 11 illustrates operations performed to execute scrollable cursor fetch operations in accordance with implementations of the invention; and

FIG. 12 illustrates a computing architecture that may be used with the described implementations.

### DETAILED DESCRIPTION OF THE PREFERRED EMBODIMENTS

In the following description, reference is made to the accompanying drawings which form a part hereof, and which illustrate several embodiments of the present invention. It is understood that other embodiments may be utilized and structural and operational changes may be made without departing from the scope of the present invention.

### Data Partitioned Secondary Index

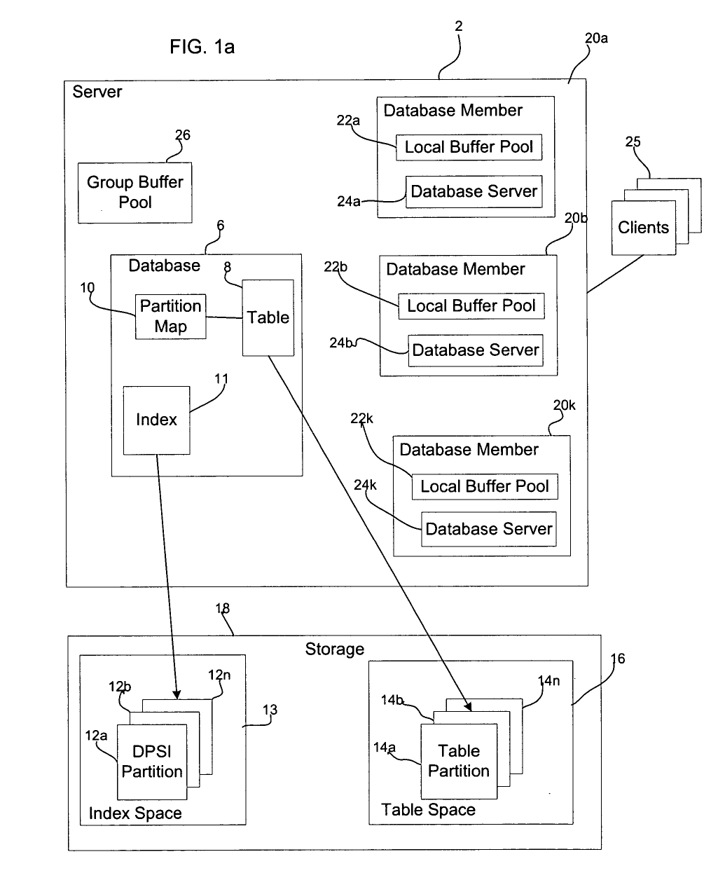

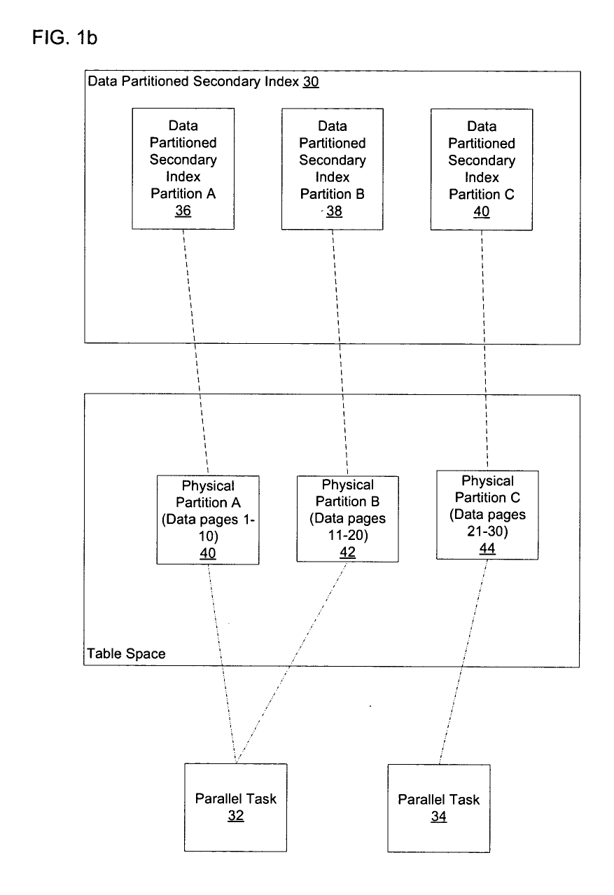

FIG. 1a illustrates a computing environment in which a database may be implemented. A server 2, which may comprise any server class system known in the art, receives and handles database requests, such as database queries, directed to tables or indexes in a database 6. Database 6 is shown as having a table 8, a partition map 10, and an index 11. The partition map 10 identifies one or more columns of the table 8 as partition map columns, and uses the partition map column values to associate table rows with one partition 14a, 14b . . . 14n in a table space 16 in storage 18 where the table 8 data is stored. The partition map 10 criteria may indicate ranges of values associated with different partitions 14a, 14b . . . 14n defined for the table 8, such that when adding a row to the table 8, the column value for the added row corresponding to the partition map column determines in which partition 14a, 14b . . . 14n the row will be stored. For instance, the partition map 10 may indicate a range of partition map column values for each partition 14a, 14b . . . 14n, such that the row is stored in the partition associated with the range including the column value of the row.

The index 11 on the table 8 may be implemented as a plurality of data partitioned secondary indexe (DPSI) partitions 12a, 12b . . . 12n in an index space 13, where each DPSI partition 12a, 12b . . . 12n provides a scannable index on a subset of rows of the table 8. This makes the index 11 partitioned. In certain implementations, each DPSI partition 12a, 12b . . . 12n is associated with one table space partition 14a, 14b . . . 14n, such that each DPSI partition 12a, 12b . . . 12n has nodes arranged in a tree structure, such as a B-tree, where each node has a key value for one table record and a location identifier, such as record identifier (RIDs), pointing to the corresponding table row in the table space partition 14a, 14b . . . 14m. In this way, the rows in the table 8 in one table space partition 14a, 14b . . . 14n may be separately searched by searching the DPSI partitions 12a, 12b . . . 12n that includes the key value for each row in the table space partition 14a, 14b . . . 14n associated with that DPSI partition 12a, 12b . . . 12n.

FIG. 1b provides a further example of a data partitioned secondary index (DPSI) and, in particular, a mapping of a data partitioned secondary index 30 to physical partitions on storage device 18 against which parallel tasks 32, 34 execute in accordance with certain implementations of the invention. In particular, the data partitioned secondary index (DPSI) 30 is partitioned into three partitions: data partitioned secondary index (DPSI) partition A 36, data partitioned secondary index (DPSI) partition B 38, and data partitioned secondary index (DPSI) partition C 40. Storage device 18 stores physical partition A 40 with data pages 1-10, physical partition B 142 with data pages 11-20, and physical partition C 144 with data pages 21-30. Each data partitioned secondary index (DPSI) partition is associated with a physical partition. For example, data partitioned secondary index (DPSI) partition A 36 is associated with physical partition A 40. Data partitioned secondary index (DPSI) partition B 38 is associated with physical partition B 42. Data partitioned secondary index (DPSI) partition C 40 is associated with physical partition C 44. Additionally, parallel task 32 is assigned data pages 1-10 of physical partition A 40 and data pages 11-20 of physical partition B 42. Parallel task 34 is assigned data pages 21-30 of physical partition C 46.

By assigning data pages to parallel tasks, certain implementations of the invention, further discussed in detail in U.S. patent application Ser. No. 10/353,138, which was incorporated by reference in its entirety above, are able to map the data pages to physical partitions, which are then mapped to associations with data partitioned secondary index partitions. Since different parallel tasks access different data pages and different data partitioned secondary index partitions, I/O contention between parallel tasks is minimized and overall elapsed time is reduced. Thus, implementations of the invention achieve an elapsed time improvement over sequential database query execution by creating multiple parallel tasks to concurrently access data through a data partitioned secondary index and by using data page range partitioning (i.e., assigning different data page ranges to different parallel tasks having the same key range).

The storage 18 may comprise any type of non-volatile storage device known in the art. Further, pages of any of the table space partitions 12a, 12b . . . 12n and 14a, 14b . . . 14m, or part thereof, may be loaded into the memory of the server 2 or the database members 20a, 20b . . . 20n.

Although only one table 8, partition map 10, index 11 and one set of DPSI partitions 12a, 12b . . . 12n and table space partitions 14a, 14b . . . 14n are shown, the database 6 may include many tables and DPSIs, as well as additional sets of index and table space partitions for the tables and indexes in the database 6. Moreover, multiple DPSIs defined on one table may each be comprised of multiple partitions, where each DPSI has a different set of key columns on the table.

Database members 20a, 20b . . . 20k include a local buffer pool 22a, 22b . . . 22k to store records retrieved from the database 6 and a database server 24a, 24b . . . 24k, such as a database management server (DBMS), to receive requests from database clients 25 and execute such requests against the database 6. The database clients initiating the requests may execute within the server 2 or on a system external to the server 2. The database server 24a, 24b . . . 24k may then perform operations on database 6 data retrieved through the database server 24a, 24b . . . 24k written to the local buffer pool 22a, 22b . . . 22k. When modifying data in a local buffer pool 22a, 22b . . . 22k, the database servers 24a, 24b . . . 24k would write any modifications to a group buffer pool 26. Any database server 24a, 24b . . . 24k accessing database data in their local buffer pool 22a, 22b . . . 22k would first check the group buffer pool 26 to determine if there is a more recent version of the data they are accessing, and if so, access such more recent version of the data from the group buffer pool 26.

The database member 20a, 20b . . . 20n may be implemented in computer systems separate from the server 2. Alternatively, the database members 20a, 20b . . . 20n may comprise programs or processes that execute within the server 2.

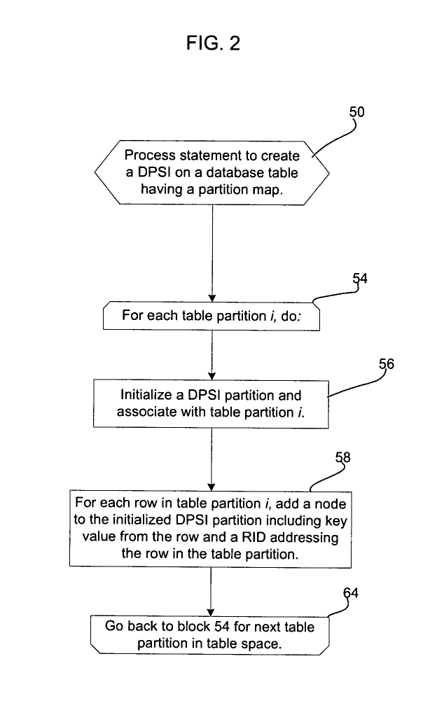

FIG. 2 illustrates operations performed by the database servers 24a, 24b . . . 24k to create an index and a data partitioned secondary index (DPSI) on a table 8 having a partition map. Upon receiving (at block 50) a statement, such as a structured query language (SQL), to create a DPSI index 11 on one or more key columns of a table 8, the database server 24a, 24b . . . 24k then performs a loop blocks 54 through 64 for each table space partition i. For each partition i, the database server 24a, 24b . . . 24k initializes (at block 56) a DPSI partition 12a, 12b . . . 12n having one or more columns corresponding to one or more columns in the table 8. Thus, each initialized DPSI partition 12a, 12b . . . 12n corresponds to one of the table space partitions 14a, 14b . . . . 14n, such that the DPSI partitions will provide the index 11 key values for rows in the table space partition 14a, 14b . . . 14n in an index data structure, such as a searchable tree or B-tree type index data structure. For each row in table space partition i, the database server 24a, 24b . . . 24k adds (at block 58) a node to the DPSI partition 12a, 12b . . . 12n corresponding to table space partition i, including the key value (one or more key column values) from the row and a record identifier (RID), or other location identifier, addressing the added row in the table space partition i. Thus, each DPSI partition 12a, 12b . . . 12n includes one node for each row in the corresponding table space partition 14a, 14b . . . 14n. After a DPSI partition is initialized, the operation at step 58 may be deferred, such that the nodes including data from the table partition may be added at a later time. Further, the creation of the DPSI partition itself may also be deferred.

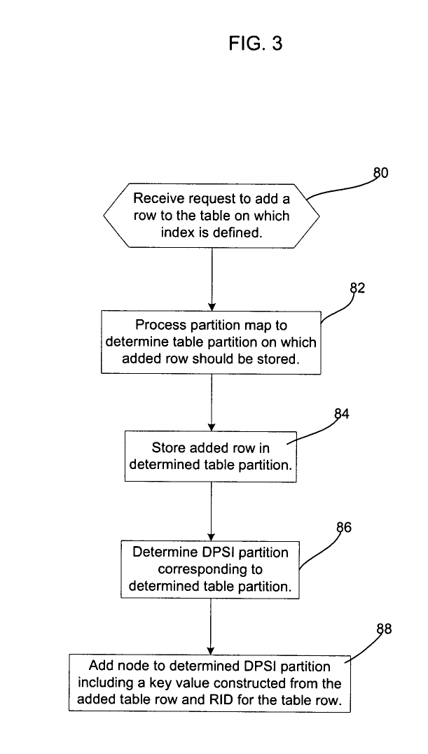

FIG. 3 illustrates operations performed by the database server 24a, 24b . . . 24k to add a row to the table 8. Upon receiving (at block 80) a request to add a row to the table 8 on which a DPSI is defined, the database server 24a, 24b . . . 24k processes (at block 82) the partition map 10 to determine the partition 14a, 14b . . . 14n on which the added row should be stored. As discussed, the partition map 10 may associate different partition map column values, or ranges of values, to specific table space partitions 14a, 14b . . . 14n. In such implementations, the partition map 10 maps table rows to a corresponding table space partition 14a, 14b . . . 14n based on the partition map column value for that added row. The added row is then stored (at block 84) in the determined table space partition 14a, 14b . . . 14n. The database server 24a, 24b . . . 24k then determines (at block 86) the DPSI partition 12a, 12b . . . 12n corresponding to the determined table space partition. A node is then added (at block 88) to the determined DPSI partition 2a, 12b . . . 12n including a key value constructed from the added table row and the location identifier, e.g., RID, of the added table row. In this way, only the particular DPSI partition 12a, 12b . . . 12n corresponding to the table space partition 14a, 14b . . . 14n in which the row is added is updated with a new node for the added table 8 row.

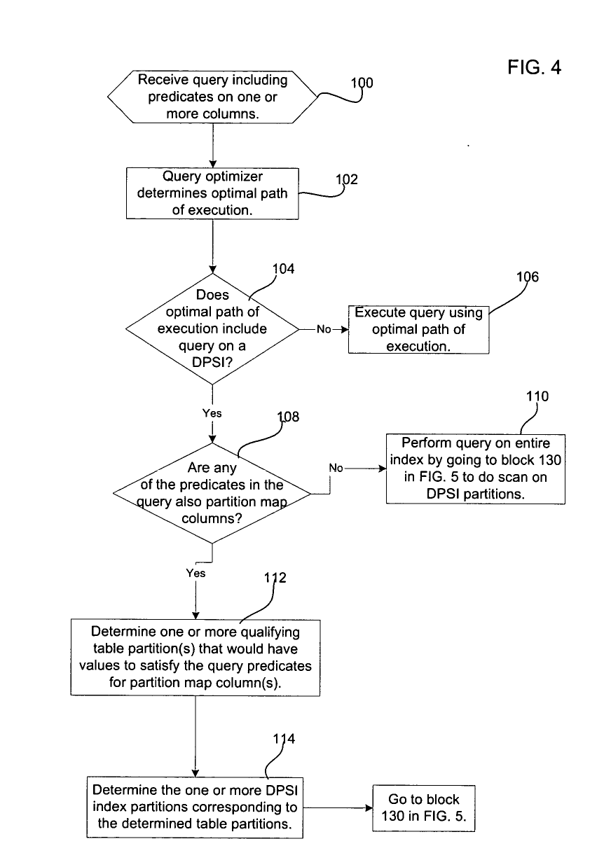

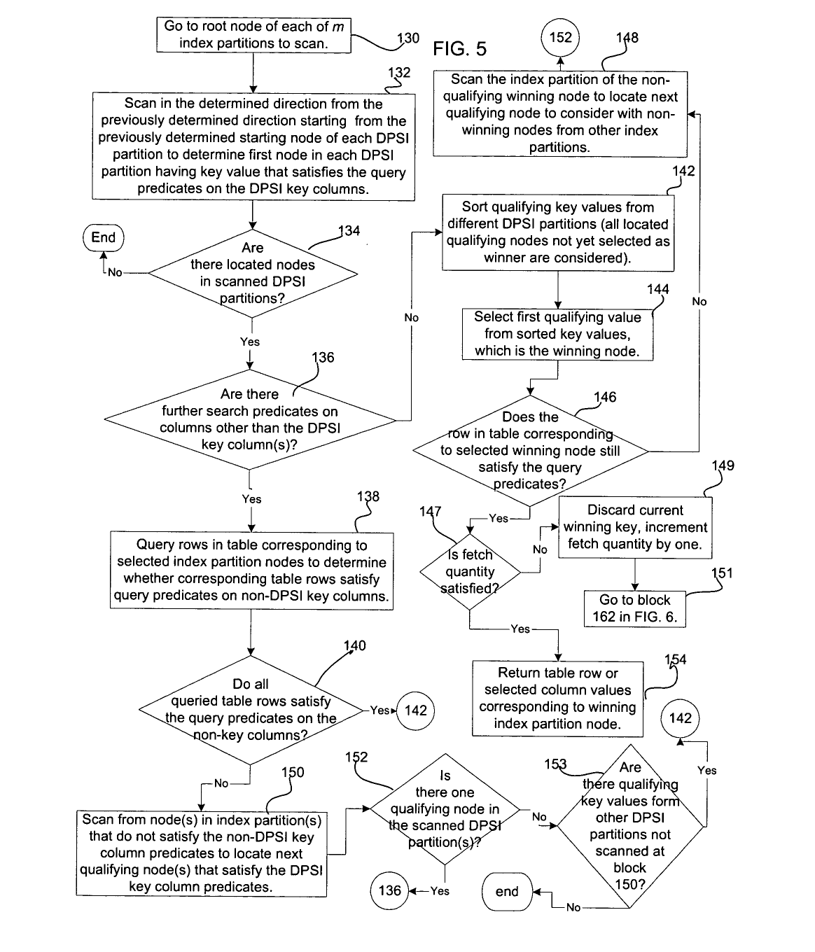

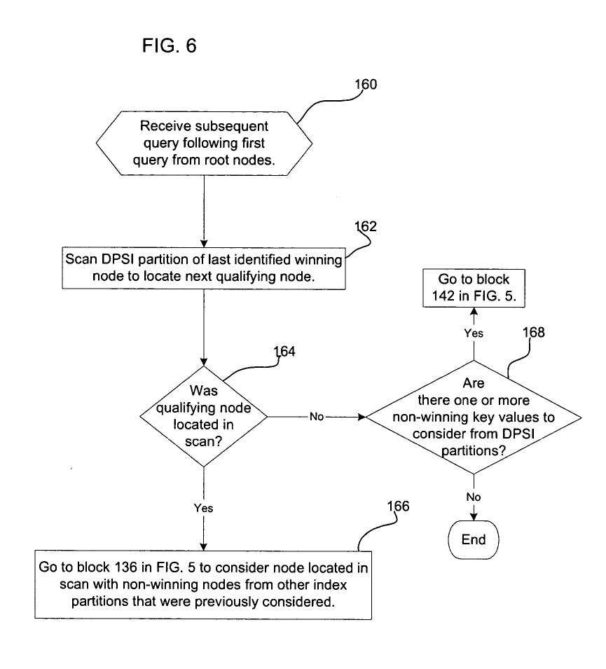

FIGS. 4, 5, and 6 illustrate operations performed by the database server 24a, 24b . . . 24k to process a query on the table 8 transmitted from one of the database members 20a, 20b . . . 20n. The database server 24a, 24b . . . 24k would include a query engine (not shown) to execute database queries against tables in the database 6. With respect to FIG. 4, upon receiving (at block 100) a query including search predicates on one or more columns in the table 8, a query optimizer in the database server 24a, 24b . . . 24k determines (at block 102) an optimal path of execution for the query. If (at block 104) the optimal path does not use a DPSI, then the database server 24a, 24b . . . 24k executes (at block 106) the query against the table and/or any non-DPSI indexes in a manner known in the art. Otherwise, if (at block 104) the optimal execution path does include a DPSI, then a determination is made (at block 108) of whether any of the predicates in the query also include partition map columns. If not, then the search cannot be limited to a particular partition, and the database server 24a, 24b . . . 24k proceeds (at block 110) to block 130 in FIG. 5 to perform a query on all the DPSI partitions 12a, 12b . . . 12n for index nodes whose key column value(s) satisfy the query search predicates.

If (at block 108) the query includes search predicates on partition map columns, then a determination is made (at block 112) of the one or more qualifying table space partitions associated with column values in the partition map 10 that are capable of satisfying the query search predicates. A determination is then made (at block 114) of the DPSI partitions 12a, 12b . . . 12n corresponding to the determined table space partitions 14a, 14b . . . 14n having index nodes whose key values are capable of satisfying one or more of the query search predicates. Control then proceeds to block to block 130 in FIG. 5 to scan the determined DPSI partitions that are capable of having qualifying key values.

To perform the first scan (from blocks 110 or 114), then the database server 24a, 24b . . . 24k accesses (at block 130) the root, or the top, of each of the m DPSI partitions 12a, 12b . . . 12n to scan, where m may be n or less than n. The database server 24a, 24b . . . 24k then scans (at block 132) in the determined direction from the previously determined starting node of each of the m DPSI partitions 12a, 12b . . . 12n to determine the first node in each DPSI partition whose key value satisfies the query predicates. The scan direction and starting node may be determined by the logic of FIG. 11. If (at block 134) no qualifying nodes are located in the any of the scanned DPSI partitions 12a, 12b . . . 12n, then control ends. Otherwise, if the one or more nodes are located, then a determination is made (at block 136) whether there are further search predicates on columns other than the DPSI key columns. If so, then the database server 24a, 24b . . . 24k processes (at block 136) table rows corresponding to the qualifying DPSI nodes (which would be the table rows whose RID (location identifier) is included in the located qualifying nodes from the scanned DPSI partitions) to determine if the table rows satisfy the query predicates on non-DPSI key columns.

If (at block 140) all queried table rows satisfy the query predicates on the non-key columns, then the qualifying key values located in each scanned DPSI partition are sorted (at block 142) if there are multiple nodes according to the sort order of the index. If the index is sorted in an ascending order, then the key values would be sorted from lowest to highest, if a descending order, then the key values would be sorted from highest to lowest. In certain implementations, each DPSI may comprise a B-tree or other searchable tree data structure having a root or top node and descendant nodes organizing one or more key columns according to a sort criteria. The first qualifying key value is selected (at block 144) from the sorted one or more located key values. The index node of the selected qualifying key values is now the winning node. The database server 24a, 24b . . . 24k then reevaluates (at block 146) whether the key value of the winning node still satisfies the query predicate search conditions (on both DPSI key columns and non-DPSI key columns), in the event the row has been updated while doing the search. This reevaluation ensures only qualifying rows are returned. If (at block 146) the row corresponding to the winning index node still satisfies the query predicates, then a determination is made (at block 147) whether the fetch quantity is satisfied. If the fetch request is to fetch forward or backward by a certain quantity or number, then the row is only returned when that fetch quantity is reached. If (at block 147) the fetch quantity is not satisfied, then the current winning key is discarded (at block 149) and the fetch quantity is incremented by one. Control then proceeds to block 162 in FIG. 6. If the fetch quantity is satisfied (from the yes branch of block 147) then the table row corresponding to the winning node or selected columns from that row are returned (at block 154). Otherwise, if (at block 146) the winning node does not still qualify, due to an intermediate update, then the database server 24a, 24b . . . 24k scans (at block 148) from the winning node to determine the next key value in that DPSI partition of the winning node that satisfies the query predicates on the DPSI key columns. Control then proceeds to block 152.

If (at block 140) the queried table rows do not satisfy the query predicates on the non-DPSI key columns, the database server 24a, 24b . . . 24k scans (at block 150) from node(s) in DPSI partition(s) of the node(s) that do not satisfy the non-DPSI key column predicates to locate next qualifying node(s) that satisfy the DPSI key column predicates. If (at block 152) there is one qualifying node located in the DPSI partitions scanned at block 150 that satisfies the key column predicates, then control proceeds to block 136. Otherwise, if (at block 152) there are no nodes that satisfy the DPSI key column predicates determined in the scan at block 150, then control proceeds to block 153 to determine whether there are qualifying key values form other DPSI partitions not scanned at block 150. If so, control proceeds to block 142, otherwise, control ends.

With respect to FIG. 6, upon receiving (at block 160) a subsequent query on the index following the first query at block 130, the database server 24a, 24b . . . 24k scans (at block 162) the DPSI partition of the last returned winning node to locate the next qualifying node. If (at block 164) a node was located in the scan at block 162, then control proceeds to block 136 in FIG. 5 to consider the node located in the scan at block 162 of the DPSI partition including the previously selected winning node with non-winning nodes from other index partitions that were previously considered, but not selected as winning nodes. If (at block 164) a qualifying node was not located in the scan at block 162 and if (at block 168) there are one or more non-winning key values to consider from DPSI partitions previously scanned, then control proceeds to block 142 in FIG. 5. Otherwise, control ends if there are no further DPSI partitions to consider.

The described logic of FIGS. 4, 5, and 6 implements a query by allowing for a query of DPSI partitions on a table so as to determine table rows having qualifying key column values in the multiple index partitions according to the ordering of the key columns in the index. In alternative implementations, the selection of the key values form the qualifier group may be based on some other criteria to allow for sorting in a descending order. For instance, the scanning can start from the last node in the DPSI partitions 12a, 12b . . . 12n and then select a highest value from the qualifying group to determine qualifying key columns in an descending order.

The described implementations provide a technique to limit a query to a subset of the multiple index (DPSI) partitions when possible and return rows in the order of the key columns of the index while the same range of key values can exist across multiple index partitions. This avoids the need to query an entire index. Instead, the query is optimized by, in certain instances, limiting the query to an index partition that has fewer searchable entries than an index on all rows of the table, where each index partition provides an index on a subset of table 8 rows stored in a particular partition 14a, 14b . . . 14n.

### Using Scrollable Cursors with a Data Partitioned Index

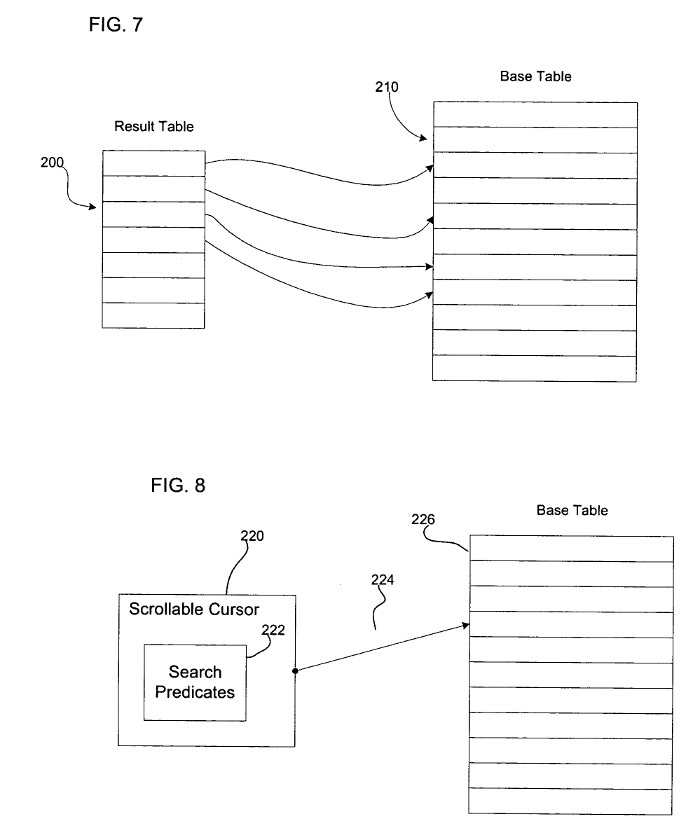

In certain implementations, the database server programs 24a, 24b . . . 24k would have the capability to implement a scrollable cursor. FIG. 7 illustrates how rows in a cursor result 200 table correspond to rows in a database table 210. As discussed, the declaration of the cursor would provide a SELECT statement specifying columns of the database table 8 (FIG. 1) and a WHERE clause including one or more predicates to include in the cursor only those table rows that satisfy the search predicates. The database server 24a, 24b . . . 24k would return to the cursor the selected columns in the select list from rows that satisfy the WHERE statement. If the select list includes an expression comprising an operation involving one or more columns, then the database server 24a, 24b . . . 24k would further return the result of such operation. The database server 24a, 24b . . . 24k would also populate the result table 200 with the returned results. In static cursor implementations, the result table 200 is implemented as a standard database table, as opposed to a temporary workfile. Further details of a static cursor are described in the above referenced patent application “Method, System, and Program for Implementing Scrollable Cursors in a Database”, having U.S. application Ser. No. 09/656,558, which patent application was incorporated herein by reference above.

In a dynamic scrollable cursor, the cursor operations, such as fetch forward, backward, relative, etc., are performed directly on a table 8 or index 11 on the table without using a result set. This avoids the need to first buffer those table rows that qualify according to the search predicate in a separate result table 200 (FIG. 7).

Dynamic scrollable cursors provide access to the current the data because the scrollable cursor operates against the table 8 or index 11 on the table. FIG. 8 illustrates data structures the database server 24a, 24b . . . 24k maintains to implement a dynamic scrollable cursor included in scrollable cursor 220, which would be created in response to commands from the database clients 25 to initiate a scrollable cursor. The scrollable cursor 220 includes search predicates 222, which include the search predicate provided with the SQL command to create the scrollable cursor 220. The scrollable cursor 220 further includes a pointer 224 also known as a “cursor”, which addresses the current row in the table 226 being accessed.

In certain implementations, the scrollable cursor may be defined to scroll on search predicates including a key column of an index on a table. For such cursors, the scrollable cursor would scroll on the index, and upon locating an index node satisfying the search predicates of the scrollable cursor, return the row in the table addressed by the index node located in the scrollable cursor fetch operation.

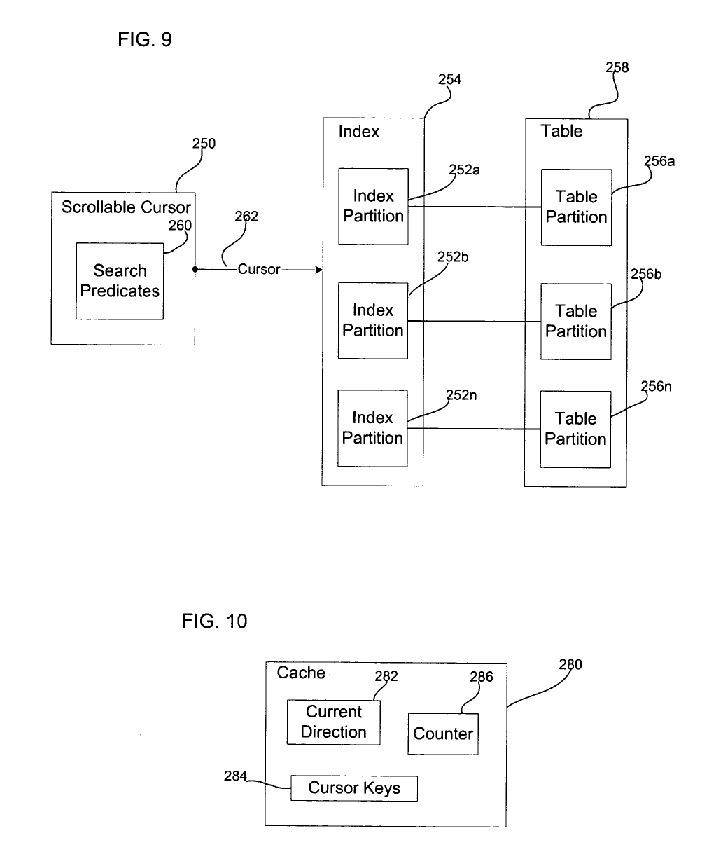

FIG. 9 illustrates a scrollable cursor 250 that scrolls on index partitions 252a, 252b . . . 252n of an index 254, where each index partition 252a, 252b . . . 252n corresponds to table partitions 256a, 256b . . . 256n, respectively, in which rows of a table 258 are stored. The scrollable cursor selects those rows from the table that satisfy search predicates 260, where the search predicates define search criteria on one or more key columns included in the nodes of the index partitions 252a, 252b . . . 252n. The scrollable cursor 250 maintains a cursor 262 that addresses a current node in one of the index partitions 252a, 252b . . . 252n that corresponds and identifies the current row in the table 258. The row in the table 258 corresponding to the index node addressed by the cursor 250 is the node that may be fetched.

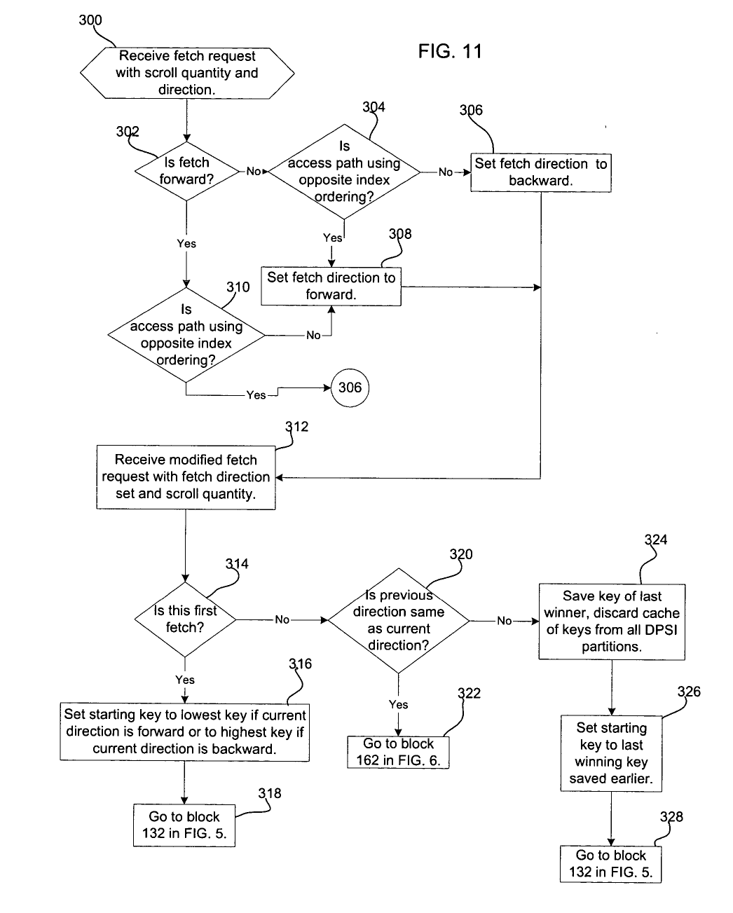

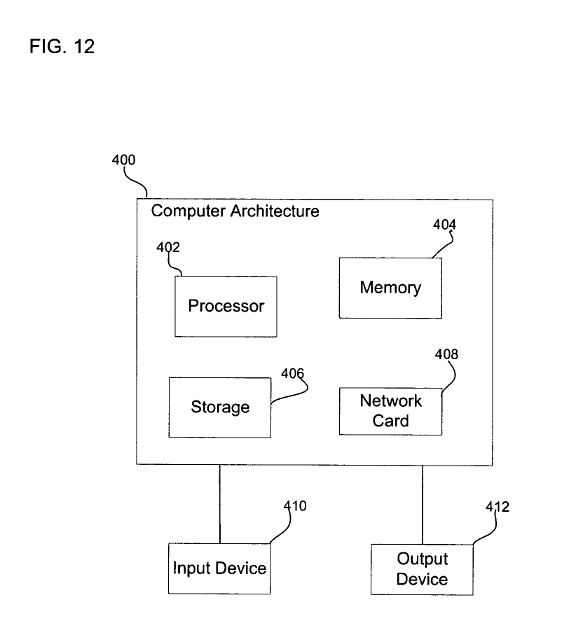

FIG. 10 illustrates data structures the database servers 24a, 24b . . . 24k maintain in a memory cache 280 to perform scrollable cursor fetch operation. A database server maintains a previous direction field 282 that indicates the direction of the previous fetch operation, i.e., forward or previous, or no value if no fetch operation was previously performed.. A current direction 283 indicates the direction of the current fetch request. A cursor keys 284 indicates one key column value from each index partition 252a, 252b . . . 252n or the end of file code. A counter 286 indicates a number of fetch back or next operations when performing a fetch relative or absolute operation to move the cursor 262 a relative number of multiple index nodes through the index partitions 252a, 252b . . . 252n. The counter 286 comprises the fetch quantity, the number of rows to move in the fetch operation, incremented at block 149 in FIG. 5.

FIG. 11 illustrates logic implemented in the database servers 24a, 24b, 24k to perform a fetch request on a defined scrollable cursor 250. Upon receiving (at block 300) a fetch (forward) request with a scroll quantity and direction, the database server 24a, 24b . . . 24k determines (at block 302) whether the fetch is to fetch forward. If not, i.e., the fetch is fetch backward, and if (at block 304) the current direction 283 of the access path uses opposite index scan, then the current direction 283 is set (at block 308) to forward; otherwise, the current direction 283 is set (at block 306) to backward. An example of the current fetch direction being opposite of the index ordering would be if the index comprised integers ordered in ascending order and the fetch was fetching in a descending direction. If (at block 302) the fetch is fetch forward and if (at block 310) the access path using opposite index ordering, then the current fetch direction 283 is set (at block 306) to backward; otherwise, the current fetch direction 283 is set (at block 308) to forward.

From block 306 or 308, the database server 24a, 24b . . . 24k receives (at block 312) the modified fetch request with the fetch direction 282 set and a scroll quantity, or number of rows to scroll in the set current direction 283. If (at block 314) this is the first fetch, i.e., the counter 286 is set to zero, then the starting cursor keys 284 are set (at block 316) for each DPSI partition 252a, 252b . . . 252n to the last key if the current direction 283 is forward or to the highest key if the current direction 283 is backward. Control then proceeds (at block 318) to block 132 in FIG. 5. As mentioned, the counter 286 (FIG. 10) comprises the fetch quantity that is incremented at block 149 in FIG. 5. If (at block 314) this is not the first fetch, i.e., the counter 286 is greater than zero, and if (at block 320) the previous direction 282 is the same as the current direction 283, then control proceeds to block 162 in FIG. 6 to scan forward to next qualifying node. Otherwise, if (at block 320) the directions 282 and 283 are not the same, then the key of the last winner is saved (at block 324) and the cursor keys 284 for all DPSI partitions 252a, 252b . . . 252n are discarded from cache. The starting key is then set (at block 326) to the last winning key saved at block 324 and then control proceeds to block 132 in FIG. 5 to scan forward to locate qualifying nodes in each DPSI partition 252a, 252b . . . 252n.

The above described cursor implementations allows cursor fetch forward or backward operations on an index of a table that is implemented in multiple index partitions.

The logic of FIG. 11 may also apply to additional fetch operations, such as fetch relative, fetch absolute, etc. For a fetch relative, the database server 24a, 24b . . . 24k would scan through the index a fixed number of times equal to the number of rows to fetch relative from a current cursor position. The counter 286 may be used to indicate the number of fetch operations that are performed, which is the fetch relative number, before returning the table row corresponding to the fetched index node. For instance for a fetch relative in the forward direction, the database server 24a, 24b . . . 24k would perform the fetch operations a number of iterations equivalent to the number indicated in the counter 286 before returning a qualifying row at block 154 in FIG. 5. For a fetch relative in the backward direction, the database server 24a, 24b . . . 24k would perform the fetch operations a number of iterations equivalent to the number of rows indicated in the counter 286 before returning data from a qualifying row at block 154 in FIG. 5. For a fetch absolute in the forward direction a fixed number of rows, the database server 24a, 24b . . . 24k would perform the fetch operations from the top node of each index partition a number of iterations indicated in the counter 286 to fetch absolute forward before returning data from the qualifying row at the specified absolute distance. For a fetch absolute in the backward direction a fixed number of rows, the database server 24a, 24b . . . 24k would perform the fetch operations from the bottom node of each index partition a number of iterations equal to the counter 286 to fetch absolute backward before returning data from the qualifying row at the specified absolute distance.

The following example illustrates dynamic scrolling with DPSI. If, for example, there are four partitions having key values in the DPSI in ascending order and the application SELECT statement requests these values in ascending order, and it is able to scan backwards as well.

| Part 1 | Part 2 | Part 3 | Part 4 |
|---|---|---|---|
| 4 | 6 | 5 | 2 |
| 12 | 11 | 8 | 10 |

After open cursor, FETCH NEXT will build the following key values in the cache: 4, 6, 5, 2 which are the lowest key from each part. After sorting, the ordered key values are 2, 4, 5, 6, the lowest, 2, is returned. On the subsequent FETCH NEXT, 2, will be discarded because it has already been returned and it will be replaced by the next key from part 4, which is 10. After sorting the cache will hold 4, 5, 6, 10. And 4 will be returned. On yet another FETCH NEXT, the cache will contain 5, 6, 10, 12, and 5 will be returned.

If the application switches direction and requests fetch previous, the cache is discarded and replaced (at block 324 in FIG. 11) since everything in the cache is greater than 5. For the new cache, new keys are retrieved by fetching backward from the nodes having key column value in qualifying keys to determine previous nodes having key column value greater than 5, which is the lowest of the key column values. This backward scan will return key values 2 and 4 from index partitions 4 and 1, respectively, with end of file being returned for the other index partitions. The cache now contains 4 and 2. The DPSI will now invert the keys and sort the inverted keys in ascending order so that the previous key is at the top of the buffer to return 4. In this way, the key to be returned is sorted to the top whether fetching backward or forward.

### Additional Implementation Details

The described database management techniques disclosed herein may be implemented as a method, apparatus or article of manufacture using standard programming and/or engineering techniques to produce software, firmware, hardware, or any combination thereof. The term “article of manufacture” as used herein refers to code or logic implemented in hardware logic (e.g., an integrated circuit chip, Programmable Gate Array (PGA), Application Specific Integrated Circuit (ASIC), etc.) or a computer readable medium, such as magnetic storage medium (e.g., hard disk drives, floppy disks,, tape, etc.), optical storage (CD-ROMs, optical disks, etc.), volatile and non-volatile memory devices (e.g., EEPROMs, ROMs, PROMs, RAMs, DRAMs, SRAMs, firmware, programmable logic, etc.). Code in the computer readable medium is accessed and executed by a processor complex. The code in which preferred embodiments are implemented may further be accessible through a transmission media or from a file server over a network. In such cases, the article of manufacture in which the code is implemented may comprise a transmission media, such as a network transmission line, wireless transmission media, signals propagating through space, radio waves, infrared signals, etc. Thus, the “article of manufacture” may comprise the medium in which the code is embodied. Additionally, the “article of manufacture” may comprise a combination of hardware and software components in which the code is embodied, processed, and executed. Of course, those skilled in the art will recognize that many modifications may be made to this configuration without departing from the scope of the present invention, and that the article of manufacture may comprise any information bearing medium known in the art.

The discussion and flowcharts in FIGS. 6 and 7 describe specific operations occurring in a particular order. In alternative implementations, certain of the logic operations may be performed in a different order, modified or removed. Morever, steps may be added to the above described logic and still conform to the described implementations. Further, operations described herein may occur sequentially or certain operations may be processed in parallel, or operations described as performed by a single process may be performed by distributed processes.

The partitions for which an index partition is provided may comprise a portion of a page set or any other portion of a physical storage unit which is provided to store database tables.

The described implementations implemented the database server in a server accessible to multiple database members. In alternative implementations, the operations described with respect to the database server may be performed by any database program handling database operations and database tables and indexes, including database programs that execute on computers other than servers.

FIG. 8 illustrates one implementation of a computer architecture 400 of the computing environment shown in FIG. 1. The architecture 400 may include a processor 402 (e.g., a microprocessor), a memory 404 (e.g., a volatile memory device), and storage 406 (e.g., a non-volatile storage, such as magnetic disk drives, optical disk drives, a tape drive, etc.). The storage 406 may comprise an internal storage device or an attached or network accessible storage. Programs in the storage 406 are loaded into the memory 404 and executed by the processor 402 in a manner known in the art. The architecture further includes a network card 408 to enable communication with a network. An input device 410 is used to provide user input to the processor 402, and may include a keyboard, mouse, pen-stylus, microphone, touch sensitive display screen, or any other activation or input mechanism known in the art. An output device 412 is capable of rendering information transmitted from the processor 402, or other component, such as a display monitor, printer, storage, etc.

The foregoing description of the implementations has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many implementations of the invention can be made without departing from the spirit and scope of the invention, the invention resides in the claims hereinafter appended.

1. A method for accessing data in a database table, comprising:
receiving a fetch request to fetch data from a base table that satisfies a query predicate, wherein rows of the base table are stored in table partitions and wherein there is one index partition for each determined table partition, wherein each index partition includes nodes, wherein each node in each index partition includes at least one key column value from a corresponding table row in the table partition associated with the index partition and a location identifier identifying the corresponding table row in the corresponding table partition;
determining a set of nodes, one from each index partition, whose key column value satisfies the query predicate;
selecting one node from the set; and
returning data from the table row identified by the location identifier in the selected node in response to the fetch request.

2. The method of claim 1, further comprising:
determining whether to modify a direction of the fetch request;
modifying the direction of the fetch request if the determination is made to modify the fetch request; and
determining the set of nodes based on the direction of the fetch request.

3. The method of claim 2, wherein determining whether to modify the direction of the fetch request is based on a current fetch direction and whether the current fetch direction is opposite an ordering of the index partitions.

4. The method of claim 2, wherein modifying the direction of the fetch request comprises:
setting the fetch direction to backward if the fetch direction is backward and the fetch direction is not opposite index ordering or if the fetch direction is forward and the fetch direction is opposite index ordering; and
setting the fetch direction to forward if the fetch direction is backward and the fetch direction is opposite index ordering or if the fetch direction is forward and the fetch direction is not opposite index ordering.

5. The method of claim 2, further comprising:
if the fetch request is a first fetch of the fetch request, then selecting one node starting from one of: a lowest key value from each index partition if the fetch direction is forward or highest key value from each index partition if the fetch direction is backward.

6. The method of claim 2, further comprising:
if the fetch request is not a first fetch of the fetch request, then determining whether a previous direction of a previous fetch request is a same direction as the direction of the fetch request, wherein the direction of the fetch request is capable of having been modified; and
if the previous and current directions are different, then discarding all saved nodes for the index partitions and selecting one node from a last selected node.

7. The method of claim 6, further comprising:
if the previous and current directions are the same, then scanning in the direction of the fetch request from the previously saved node in each index partition.

8. The method of claim 1, further comprising:
receiving a subsequent fetch request to fetch data from the base table;
replacing a previously selected node selected in a previous fetch request in the set with one node in the index partition including the previously selected node whose key column value satisfies the query predicate to form a modified set;
selecting one node from the modified set; and
returning the table row identified by the location identifier in the node selected from the modified set.

9. The method of claim 8, wherein the subsequent fetch request comprises a fetch relative request to fetch a row that is multiple number of rows from the previously selected node, further comprising:
performing the steps of replacing the previously selected node and selecting one node multiple number of times to determine the selected node to return to the fetch relative request to satisfy a fetch quantity.

10. The method of claim 8, wherein the subsequent fetch request comprises a fetch absolute request to fetch a row that is multiple number of rows from one end of the table, further comprising:
determining a new set of nodes, one from each index partition, by scanning from one end of the index partitions for a first node whose key column value satisfies the query predicate and whose key column value is greater than the previously selected node if fetching forward and the key is less than the previously selected node if fetching backward;
performing the steps of replacing the previously selected node and selecting one node a number of times that is one less than the number of rows indicated in the fetch absolute request to determine the selected node to return to the fetch relative request; and
performing the steps of replacing the previously selected node and selecting one node the multiple number of times to determine the selected node to return to the fetch relative request.

11. The method of claim 1, further comprising:
discarding the cached keys if the fetch request is in an opposite direction of a previous fetch request;
determining a new set of nodes from each index partition; and
caching the determined new set of nodes when performing the fetch operation.

12. The method of claim 1, further comprising:
processing the fetch request to determine set of nodes in the backward direction in the previous fetch request;
inverting the keys and sorting the inverted keys; and
selecting the one node containing the lowest inverted key to return.

13. A system for accessing data in a database table, comprising:
a computer readable medium;
a base table implemented in the computer readable medium;
table partitions storing rows of the base table implemented in the computer readable medium;
index partitions, wherein there is one index partition for each determined table partition, wherein each index partition includes nodes, wherein each node in each index partition includes at least one key column value from a corresponding table row in the table partition associated with the index partition and a location identifier identifying the corresponding table row in the corresponding table partition;
means for receiving a fetch request to fetch data from the base table that satisfies a query predicate;
determining a set of nodes, one from each index partition, whose key column value satisfies the query predicate;
selecting one node from the set; and
returning data from the table row identified by the location identifier in the selected node in response to the fetch request.

14. The system of claim 13, further comprising:
means for determining whether to modify a direction of the fetch request;
means for modifying the direction of the fetch request if the determination is made to modify the fetch request; and
means for determining the set of nodes based on the direction of the fetch request.

15. The system of claim 14, wherein the means for modifying the direction of the fetch request performs:
setting the fetch direction to backward if the fetch direction is backward and the fetch direction is not opposite index ordering or if the fetch direction is forward and the fetch direction is opposite index ordering; and
setting the fetch direction to forward if the fetch direction is backward and the fetch direction is opposite index ordering or if the fetch direction is forward and the fetch direction is not opposite index ordering.

16. The system of claim 13, further comprising:
means for receiving a subsequent fetch request to fetch data from the base table;
means for replacing a previously selected node selected in a previous fetch request in the set with one node in the index partition including the previously selected node whose key column value satisfies the query predicate to form a modified set;
means for selecting one node from the modified set; and
means for returning the table row identified by the location identifier in the node selected from the modified set.

17. The system of claim 13, further comprising:
means for discarding the cached keys if the fetch request is in an opposite direction of a previous fetch request;
means for determining a new set of nodes from each index partition; and
means for caching the determined new set of nodes when performing the fetch operation.

18. The system of claim 13, further comprising:
means for processing the fetch request to determine set of nodes in the backward direction in the previous fetch request;
means for inverting the keys and sorting the inverted keys; and
means for selecting the one node containing the lowest inverted key to return.

19. An article of manufacture for accessing data in a database table, wherein the article of manufacture causes operations to be performed, the operations comprising:
receiving a fetch request to fetch data from a base table that satisfies a query predicate, wherein rows of the base table are stored in table partitions and wherein there is one index partition for each determined table partition, wherein each index partition includes nodes, wherein each node in each index partition includes at least one key column value from a corresponding table row in the table partition associated with the index partition and a location identifier identifying the corresponding table row in the corresponding table partition;
determining a set of nodes, one from each index partition, whose key column value satisfies the query predicate;
selecting one node from the set; and
returning data from the table row identified by the location identifier in the selected node in response to the fetch request.

20. The article of manufacture of claim 19, wherein the operations further comprise:
determining whether to modify a direction of the fetch request;
modifying the direction of the fetch request if the determination is made to modify the fetch request; and
determining the set of nodes based on the direction of the fetch request.

21. The article of manufacture of claim 20, wherein determining whether to modify the direction of the fetch request is based on a current fetch direction and whether the current fetch direction is opposite an ordering of the index partitions.

22. The article of manufacture of claim 20, wherein modifying the direction of the fetch request comprises:
setting the fetch direction to backward if the fetch direction is backward and the fetch direction is not opposite index ordering or if the fetch direction is forward and the fetch direction is opposite index ordering; and
setting the fetch direction to forward if the fetch direction is backward and the fetch direction is opposite index ordering or if the fetch direction is forward and the fetch direction is not opposite index ordering.

23. The article of manufacture of claim 20, wherein the operations further comprise:
if the fetch request is a first fetch of the fetch request, then selecting one node starting from one of: a lowest key value from each index partition if the fetch direction is forward or highest key value from each index partition if the fetch direction is backward.

24. The article of manufacture of claim 20, wherein the operations further comprise:
if the fetch request is not a first fetch of the fetch request, then determining whether a previous direction of a previous fetch request is a same direction as the direction of the fetch request, wherein the direction of the fetch request is capable of having been modified; and
if the previous and current directions are different, then discarding all saved nodes for the index partitions and selecting one node from a last selected node.

25. The article of manufacture of claim 24, wherein the operations further comprise:
if the previous and current directions are the same, then scanning in the direction of the fetch request from the previously saved node in each index partition.

26. The article of manufacture of claim 19, wherein the operations further comprise:
receiving a subsequent fetch request to fetch data from the base table;
replacing a previously selected node selected in a previous fetch request in the set with one node in the index partition including the previously selected node whose key column value satisfies the query predicate to form a modified set;
selecting one node from the modified set; and
returning the table row identified by the location identifier in the node selected from the modified set.

27. The article of manufacture of claim 26, wherein the subsequent fetch request comprises a fetch relative request to fetch a row that is multiple number of rows from the previously selected node, wherein the operations further comprise:
performing the steps of replacing the previously selected node and selecting one node multiple number of times to determine the selected node to return to the fetch relative request to satisfy a fetch quantity.

28. The article of manufacture of claim 26, wherein the subsequent fetch request comprises a fetch absolute request to fetch a row that is multiple number of rows from one end of the table, wherein the operations further comprise:
determining a new set of nodes, one from each index partition, by scanning from one end of the index partitions for a first node whose key column value satisfies the query predicate and whose key column value is greater than the previously selected node if fetching forward and the key is less than the previously selected node if fetching backward;
performing the steps of replacing the previously selected node and selecting one node a number of times that is one less than the number of rows indicated in the fetch absolute request to determine the selected node to return to the fetch relative request; and
performing the steps of replacing the previously selected node and selecting one node the multiple number of times to determine the selected node to return to the fetch relative request.

29. The article of manufacture of claim 19, wherein the operations further comprise:
discarding the cached keys if the fetch request is in an opposite direction of a previous fetch request;
determining a new set of nodes from each index partition; and
caching the determined new set of nodes when performing the fetch operation.

30. The article of manufacture of claim 19, wherein the operations further comprise:
processing the fetch request to determine set of nodes in the backward direction in the previous fetch request;
inverting the keys and sorting the inverted keys; and
selecting the one node containing the lowest inverted key to return.
